(19) United States
(12) Patent Application Publication
(10) Pub. No.: US 2009/0307720 A1
(43) Pub. Date: Dec. 10, 2009

(54) Apparatus and Method for Providing an Emergency Alert Function for Mobile Units

(76) Inventor: Timothy Lee Turner, Indianapolis, IN (US)

Correspondence Address: Thomson Licensing LLC, P.O. Box 5312, Two Independence Way, PRINCETON, NJ, 08543-5312, US

(21) Appl. No.: 12/224,460

(22) PCT Filed: Mar. 8, 2006
(86) PCT No.: PCT/US2006/008227

§ 371 Date: Feb. 19, 2009

(51) Int. Cl. H04N 7/025; G08B 21/00

(52) U.S. Cl. 725/33; 340/686.1

(57) ABSTRACT

An apparatus provides an emergency alert function for mobile units such as motor vehicles, airplanes, portable devices and/or any other type of mobile structures. According to an exemplary embodiment, the apparatus includes a memory operative to store data including (i) location data that correlates first location information to second location information, and (ii) at least one user selected event type. A processor is coupled to the memory and is operative to determine a current location using the location data and to process a signal indicating an emergency event. The processor enables an alert output if the emergency event corresponds to the current location and the at least one user selected event type.

The present invention generally relates to an apparatus and method for providing an emergency alert function for mobile units such as motor vehicles, airplanes, portable devices and/or any other type of mobile structures.

Emergency events such as severe weather, natural disasters, fires, civil emergencies, war acts, toxic chemical spills, radiation leaks, or other such conditions can be devastating to unprepared individuals. With weather-related emergencies, authorities such as the National Weather Service (NWS) and the National Oceanographic and Atmospheric Administration (NOAA) are generally able to detect severe weather conditions prior to the general public. Through the use of modern weather detection devices, such as Doppler radar and weather satellites, the NWS and NOAA are able to issue early warnings of severe weather conditions which have saved many lives. However, for such warnings to be effective, they must be communicated to their intended recipients.

In some areas, sirens are used to alert individuals in the vicinity of immediate danger. However, these sirens can not always be heard, especially by those individuals traveling in mobile units such as motor vehicles, airplanes or other type of mobile structures. Moreover, such sirens do not provide any information regarding the nature of the danger or what action to take. In some areas, telephone alerts can be set up to provide such information to subscribers. However, such information is generally restricted to a specific geographical area where the telephone is registered. Therefore, this type of system is not designed to alert individuals that may be traveling.

Accordingly, there is a need for an apparatus and method for providing an emergency alert function that addresses the foregoing problems, and is thereby capable of alerting individuals that may be traveling regarding emergency events. The present application addresses these and/or other issues.

In accordance with an aspect of the present invention, an apparatus for providing an emergency alert function is disclosed. According to an exemplary embodiment, the apparatus comprises memory means for storing data including (i) location data that correlates first location information to second location information, and (ii) at least one user selected event type. Processing means determines a current location using the location data and processes a signal indicating an emergency event. The processing means enables an alert output if the emergency event corresponds to the current location and the at least one user selected event type.

In accordance with another aspect of the present invention, a method for providing an emergency alert function for an apparatus is disclosed. According to an exemplary embodiment, the method comprises steps of storing in a memory data including (i) location data that correlates first location information to second location information, and (ii) at least one user selected event type, determining a current location using the location data, processing a signal indicating an emergency event, and enabling an alert output if the emergency event corresponds to the current location and the at least one user selected event type.

In accordance with another aspect of the present invention, a television signal receiver having an emergency alert function is disclosed. According to an exemplary embodiment, the television signal receiver comprises a memory operative to store data including (i) location data that correlates first location information to second location information, and (ii) at least one user selected event type. A processor is coupled to the memory and is operative to determine a current location using the location data and to process a signal indicating an emergency event. The processor enables an alert output if the emergency event corresponds to the current location and the at least one user selected event type.

The above-mentioned and other features and advantages of this invention, and the manner of attaining them, will become more apparent and the invention will be better understood by reference to the following description of embodiments of the invention taken in conjunction with the accompanying drawings, wherein:

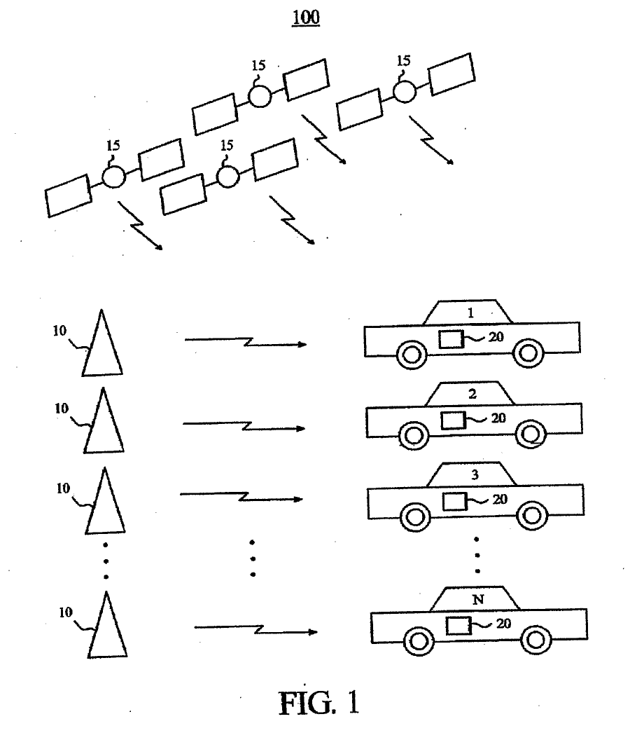

FIG. 1 is an exemplary environment suitable for implementing the present invention;

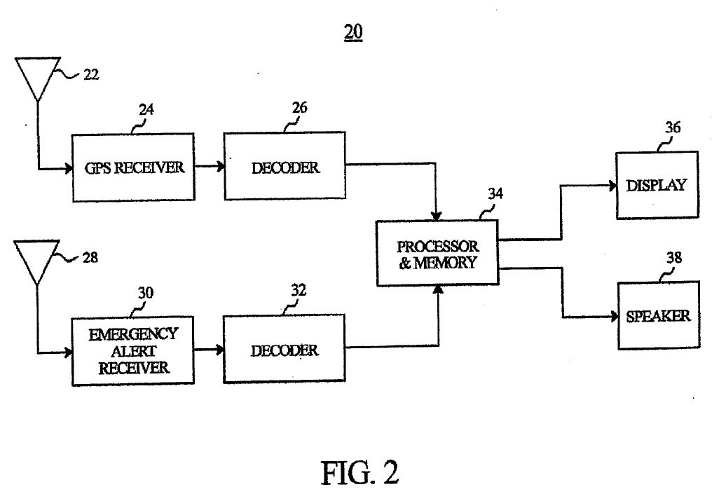

FIG. 2 is a block diagram of an apparatus having an emergency alert function according to an exemplary embodiment of the present invention; and

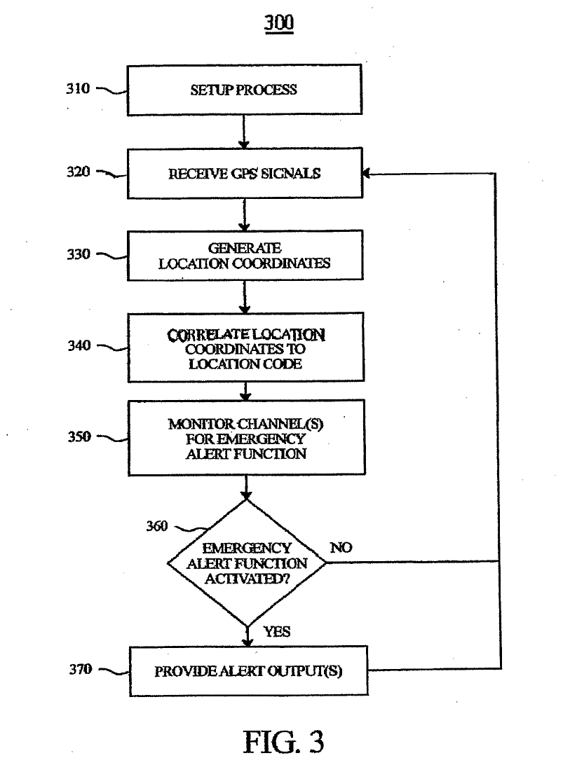

FIG. 3 is a flowchart illustrating steps for providing an emergency alert function according to an exemplary embodiment of the present invention.

The exemplifications set out herein illustrate preferred embodiments of the invention, and such exemplifications are not to be construed as limiting the scope of the invention in any manner.

Referring now to the drawings, and more particularly to FIG. 1, an exemplary environment 100 suitable for implementing the present invention is shown. Environment 100 of FIG. 1 comprises a plurality of signal transmitters 10, a plurality of satellites 15, and a plurality of apparatuses 20 each having an emergency alert function. According to an exemplary embodiment, apparatuses 20 may be included within mobile units such as motor vehicles, airplanes and/or any other type of mobile structure. For purposes of example and explanation, however, such mobile units are shown in FIG. 1 as motor vehicles (i.e., 1, 2, 3 . . . N, where N may be any positive integer), and each motor vehicle may be present in a different geographical location at any given time. Apparatus 20 may also be embodied as a portable device.

Signal transmitters 10 are each operative to transmit signals including emergency alert signals which may be received by apparatuses 20. Each signal transmitter 10 may broadcast such signals to only a limited number of geographical locations. Therefore, each apparatus 20 may be capable of receiving emergency alert signals from only one or more given signal transmitters 10. According to an exemplary embodiment, the emergency alert signals broadcast from signal transmitters 10 may be provided from an authority such as the NWS, and/or other authorities such as governmental entities. Signal transmitters 10 may transmit the emergency alert signals in their original form as provided by the authority, or may append digital data representative of the emergency alert signals to other data, or may modify the emergency alert signals in some manner appropriate for its specific transmission format needs. In response to the emergency alert signals, each apparatus 20 may provide one or more alert outputs to thereby notify individuals of the emergency event. Signal transmitters 10 may transmit signals to apparatuses 20 via any wired and/or wireless link.

Satellites 15 are each operative to transmit global positioning satellite (GPS) signals which may be received by apparatuses 20. According to an exemplary embodiment, each satellite 15 periodically transmits GPS signals that indicate its location and the current time. Satellites 15 are synchronized so that they all transmit such GPS signals at substantially the same instant in time. The GPS signals travel at the speed of light and arrive at a given apparatus 20 at slightly different times because some satellites 15 are farther away than others. Each apparatus 20 can determine the respective distances to satellites 15 by estimating the amount of time it takes to receive the GPS signals. According to an exemplary embodiment, once each apparatus 20 determines the distances to at least three satellites 15, it can calculate location coordinates that indicate its location in three dimensions.

Apparatuses 20 are each operative to provide an emergency alert function, and may be embodied as any type of electronic apparatus such as a television signal receiver, radio, and/or other apparatus. The emergency alert function enables, among other things, apparatus 20 to receive emergency alert signals and provide one or more alert outputs to notify individuals of an emergency event. According to the present invention, each apparatus 20 uses received GPS signals to generate three-dimensional location coordinates that indicate its current location. Apparatus 20 correlates the three-dimensional location coordinates to a corresponding location code indicative of the current location. Apparatus 20 then provides the emergency alert function by enabling one or more alert outputs if received emergency alert signals indicate an emergency event that corresponds to the current location and a user selected event type. Further details regarding apparatus 20 will now be provided.

Referring to FIG. 2, a block diagram of apparatus 20 of FIG. 1 according to an exemplary embodiment of the present invention is shown. Apparatus 20 of FIG. 2 comprises first antenna means such as antenna 22, first signal receiving means such as GPS receiver 24, first decoding means such as decoder 26, second antenna means such as antenna 28, second signal receiving means such as emergency alert receiver 30, second decoding means such as decoder 32, processing means and memory means such as processor and memory 34, visual output means such as display 36, and audio output means such as speaker 38. Some of the foregoing elements may for example be embodied using integrated circuits (ICs). For clarity of description, certain conventional elements associated with apparatus 20 such as certain control signals, power signals and/or other elements may not be shown in FIG. 2.

Antenna 22 is operative to receive signals including GPS signals broadcast from satellites 15. According to an exemplary embodiment, each GPS signal includes digitally encoded information indicating the time it was transmitted and the location of the particular satellite 15 it was transmitted from. As previously indicated herein, satellites 15 are synchronized so that they all transmit GPS signals at substantially the same instant in time. The GPS signals travel at the speed of light and are received by antenna 22 at slightly different times because some satellites 15 are farther away than others.

GPS receiver 24 is operative to tune and process signals including the GPS signals received by antenna 22. According to an exemplary embodiment, GPS receiver 24 tunes one or more predetermined channel frequencies to thereby receive the GPS signals.

Decoder 26 is operative to decode signals including the GPS signals tuned by GPS receiver 24. According to an exemplary embodiment, decoder 26 extracts digitally encoded data from each GPS signal that indicates the time it was transmitted and the location of the particular satellite 15 it was transmitted from. Decoder 26 provides this digital data to processor 34.

Antenna 28 is operative to receive signals including emergency alert signals broadcast from one or more signal transmitters 10. According to an exemplary embodiment, the emergency alert signals may be digitally encoded within received audio signals. According to another exemplary embodiment, emergency alert signals may be received as separate data packets in a digital transmission system. Although FIG. 2 shows apparatus 20 as having two separate antennas, namely antennas 22 and 28, it may also be possible to implement apparatus 20 using only a single antenna.

Emergency alert receiver 30 is operative to tune and process signals including the emergency alert signals received by antenna 28. According to an exemplary embodiment, emergency alert receiver 30 is capable of tuning channels corresponding to at least the following designated NWS frequencies: 162.400 MHz, 162.425 MHz, 162.450 MHz, 162.475 MHz, 162.500 MHz, 162.525 MHz and 162.550 MHz. Such channels may provide audio signals that include digitally encoded emergency alert signals. Emergency alert receiver 30 may also tune other channels including those used in terrestrial, cable, satellite and/or other transmissions.

Decoder 32 is operative to decode signals including the emergency alert signals tuned by emergency alert receiver 30. According to an exemplary embodiment, decoder 32 extracts digitally encoded data regarding emergency events from the emergency alert signals, and provides this digital data to processor 34. Decoder 32 may also perform other decoding functions, such as decoding data which represents emergency alert signals included in the vertical blanking interval (VBI) of an analog television signal.

According to an exemplary embodiment, the digitally encoded data extracted by decoder 32 represents Specific Area Message Encoding (SAME) data associated with emergency events. This SAME data represents information such as the specific geographical location(s) affected by an emergency event, the type of emergency event (e.g., tornado watch, radiological hazard warning, civil emergency, etc.), and the expiration time of the event alert. SAME data is used by the NWS and other authorities to improve the specificity of emergency alerts and to decrease the frequency of false alerts. Other data and information may also be included in the emergency alert signals according to the present invention.

Processor and memory 34 are operative to perform various processing and data storage functions that enable the emergency alert function of apparatus 20. According to an exemplary embodiment, processor 34 is operative to generate three-dimensional location coordinates that indicate the current location of apparatus 20 responsive to digital data provided from decoder 26. As previously indicated herein, such digital data represents time and location information provided from satellites 15. In particular, each satellite 15 periodically transmits GPS signals that indicate its location and the current time. Satellites 15 are synchronized so that they all transmit such GPS signals at substantially the same instant in time. The GPS signals travel at the speed of light and are received by apparatus 20 at slightly different times because some satellites 15 are farther away than others. In this manner, processor 34 can determine the distances from apparatus 20 to the respective satellites 15 using the digital data provided from decoder 26. According to an exemplary embodiment, once processor 34 determines the distances to at least three satellites 15, it can calculate three-dimensional location coordinates for apparatus 20 using the process of “triangulation” which is generally known in the art. Other techniques for determining three-dimensional location coordinates for apparatus 20 could also be used.

Once processor 34 has generated three-dimensional location coordinates for apparatus 20, it correlates those location coordinates to a location code using data stored in memory 34. According to an exemplary embodiment, memory 34 is operatively coupled to processor 34 and stores data including location data (e.g., as a look-up table) that correlates first location information in the form of three-dimensional location coordinates (e.g., in degrees, minutes, seconds, etc.) to second location information in the form of location codes. According to this exemplary embodiment, these location codes are Federal Information Processing Standard (FIPS) location codes, although other types of location codes could also be used. The location data stored in memory 34 may be periodically updated. Processor 34 uses the location data in memory 34 to identify a FIPS code that corresponds to the three-dimensional location coordinates representing the current location of apparatus 20. The identified FIPS code is stored in memory 34 (e.g., in a predetermined memory register) and used to control the emergency alert function of apparatus 20.

Processor 34 is also operative to receive the digital data (e.g., SAME data) regarding emergency events from decoder 32 and use this digital data to determine whether the emergency alert function of apparatus 20 is activated. According to an exemplary embodiment, processor 34 compares the digital SAME data provided from decoder 32 to the aforementioned FIPS code indicating the current location of apparatus 20 and user setup data stored in memory 34 to determine whether the emergency alert function is activated. As will be described later herein, a setup process for the emergency alert function of apparatus 20 allows a user to select items such as the type(s) of emergency events (e.g., tornado watch, radiological hazard warning, civil emergency, etc.) which activate the emergency alert function. When the emergency alert function of apparatus 20 is activated, processor 34 enables one or more alert outputs (e.g., aural and/or visual) to thereby notify individuals of the emergency event. Further details regarding the aforementioned aspects of the present invention will be provided later herein.

Display 36 is operative to provide visual displays responsive to signals provided from processor 34. According to an exemplary embodiment, display 36 may provide visual (e.g., video and/or still) displays including messages that provide details regarding emergency events. Display 36 may be embodied as any type of display device and may also include one or more indicator elements such as light emitting diodes (LEDs), liquid crystal display (LCD) elements, liquid quartz display (LQD) elements, and/or other elements.

Speaker 38 is operative to provide aural outputs responsive to signals provided from processor 34. According to an exemplary embodiment, speaker 38 may provide aural outputs that provide details regarding emergency events. Although not expressly shown in FIG. 2, speaker 38 may include an audio amplifier for amplifying its aural outputs.

Turning now to FIG. 3, a flowchart 300 illustrating steps for providing an emergency alert function according to an exemplary embodiment of the present invention is shown. For purposes of example and explanation, the steps of FIG. 3 will be described with reference to apparatus 20 of FIG. 2. The steps of FIG. 3 are merely exemplary, and are not intended to limit the present invention in any manner.

At step 310, a setup process for the emergency alert function of apparatus 20 is performed. According to an exemplary embodiment, a user performs this setup process by providing inputs to apparatus 20 (e.g., using a remote control device, keypad or other input device not shown in figures) responsive to on-screen menus displayed via display 36. According to an exemplary embodiment, the user may select at least the following items during the setup process at step 310:

A. Enable/Disable—The user may select whether to enable or disable the emergency alert function.

B. Additional Geographical Location(s)—The user may select whether or not he/she wants to be notified regarding selected emergency events that occur in geographical locations in addition to the one in which apparatus 20 is currently located. For example, the user may elect to be notified regarding selected emergency events in up to “X” number of immediately surrounding geographical locations. According to an exemplary embodiment, geographical location(s) are represented by location codes, such as FIPS codes.

C. Event Types—The user may select one or more types of emergency events which activate the emergency alert function. For example, the user may designate that events such as civil emergencies, radiological hazard warnings, and/or tornado warnings activate the emergency alert function, but that events such as a thunderstorm watch does not, etc. According to the present invention, different severity or alert levels (e.g., statement, watch, warning, etc.) may represent different “events.” For example, a thunderstorm watch may be considered a different event from a thunderstorm warning.

D. Alert Outputs—The user may select one or more alert outputs to be provided when the emergency alert function is activated. According to an exemplary embodiment, the user may select visual and/or aural outputs to be provided for each type of emergency event that activates the emergency alert function. For example, the user may select to display a visual message (e.g., an NWS text message). The user may also select to aurally output a warning tone (e.g., chime, siren, etc.) and/or an audio message (e.g., NWS audio message), and the desired volume of each. Other types of alert outputs may also be provided according to the present invention.

According to the present invention, other menu selections may also be provided at step 310 and/or some of the menu selections described above may be omitted. Data corresponding to the user's selections during the setup process of step 310 is stored in memory 34.

At step 320, apparatus 20 receives GPS signals. According to an exemplary embodiment, apparatus 20 receives the GPS signals from at least three satellites 15 at step 320 via antenna 22 and GPS receiver 24. Decoder 26 decodes the GPS signals to thereby extract digitally encoded data from each GPS signal that indicates the time it was transmitted and the location of the particular satellite 15 it was transmitted from. Decoder 26 provides this digital data to processor 34.

At step 330, apparatus 20 generates location coordinates responsive to the GPS signals received at step 320. According to an exemplary embodiment, processor 34 generates three-dimensional location coordinates (e.g., in degree, minutes, seconds, etc.) at step 330 that indicate the current location of apparatus 20 responsive to the digital data provided from decoder 26. As previously indicated herein, such digital data represents time and location information provided from satellites 15. In particular, each satellite 15 periodically transmits GPS signals that indicate its location and the current time. Satellites 15 are synchronized so that they all transmit such GPS signals at substantially the same instant in time. The GPS signals travel at the speed of light and are received by apparatus 20 at slightly different times because some satellites 15 are farther away than others. In this manner, processor 34 can determine the distances from apparatus 20 to the respective satellites 15 using the digital data provided from decoder 26. According to an exemplary embodiment, once processor 34 determines the distances to at least three satellites 15, it can calculate the three-dimensional location coordinates for apparatus 20 at step 330 using the process of “triangulation” which is generally known in the art. Other techniques for determining three-dimensional location coordinates for apparatus 20 could also be used at step 330. Also, the location coordinates could be generated in only two dimensions instead of three dimensions.

At step 340, apparatus 20 correlates the location coordinates generated at step 330 to a location code. According to an exemplary embodiment, processor 34 accesses certain data in memory 34 and identifies a FIPS code corresponding to the three-dimensional location coordinates generated at step 330. As previously indicated herein, memory 34 stores data including location data (e.g., as a look-up table) that correlates first location information in the form of three-dimensional location coordinates (e.g., in degrees, minutes, seconds, etc.) to second location information in the form of location codes. According to this exemplary embodiment, these location codes are FIPS codes, although other types of location codes could also be used. Processor 34 uses the location data in memory 34 to identify a FIPS code at step 340 that corresponds to the three-dimensional location coordinates representing the current location of apparatus 20. The identified FIPS code is stored in memory 34 (e.g., in a predetermined memory register) and used to control the emergency alert function of apparatus 20. This FIPS code may of course be updated as apparatus 20 moves from one geographical location to another and receives updated GPS signals.

At step 350, apparatus 20 monitors one or more channels for its emergency alert function. According to an exemplary embodiment, emergency alert receiver 30 may tune a particular channel such as one of the NWS frequencies (e.g., 162.400 MHz, 162.425 MHz, 162.450 MHz, 162.475 MHz, 162.500 MHz, 162.525 MHz and 162.550 MHz, etc.), or may scan through a plurality of such channels to thereby receive incoming emergency alert signals.

At step 360, a determination is made as to whether the emergency alert function of apparatus 20 is activated. According to an exemplary embodiment, processor 34 makes this determination by comparing data included in the incoming emergency alert signals to data stored in memory 34. As previously indicated herein, the emergency alert signals may include digitally encoded SAME data which represents information including the type of emergency event (e.g., tornado watch, radiological hazard warning, civil emergency, etc.) and the specific geographical location(s) affected by the emergency event. According to an exemplary embodiment, processor 34 compares this SAME data to the user setup data indicating the selected types of emergency events that activate the emergency alert function (i.e., item C of step 310) and the FIPS code indicating the current location of apparatus 20 (and FIPS codes representing immediately surrounding geographical locations if selected under item B of step 310). In this manner, the emergency alert function of apparatus 20 is activated when the emergency event indicated by the emergency alert signals corresponds to: (1) any event type(s) selected by the user under item C of step 310, and (2) the current geographical location of apparatus 20, and/or any immediately surrounding geographical location(s) if selected under item B of step 310.

If the determination at step 360 is negative, process flow loops back to step 320 where apparatus 20 receives GPS signals. Alternatively, if the determination at step 360 is positive, process flow advances to step 370 where apparatus 20 provides one or more alert outputs to thereby notify individuals of the emergency event.

According to an exemplary embodiment, processor 34 enables the one or more alert outputs at step 370 in accordance with the user's selections during the setup process of step 310 (i.e., item D), and such alert outputs may be aural and/or visual in nature. For example, aural outputs such as a warning tone and/or an NWS audio message may be provided at step 370 via speaker 38, and the volume of such aural outputs may be controlled in accordance with the volume level set by the user during the setup process of step 310. Visual outputs may also be provided at step 370 via display 36 to notify individuals of the emergency event. According to an exemplary embodiment, an auxiliary information display such as an NWS text message may be provided at step 370 via display 36 under the control of processor 34. Other types of aural and/or visual alert outputs than those expressly described herein may also be provided according to the present invention. From step 370, process flow loops back to step 320 as indicated in FIG. 3.

The above-described steps of FIG. 3 enable users to be informed regarding emergency events while they are traveling. As an example, consider a user that is currently driving a motor vehicle in county “C” having a FIPS code of 018011. Assume further that the user has elected not to be notified regarding selected emergency events that occur in immediately surrounding geographical locations (i.e., see item B of step 310). While driving in county “C”, the user will be informed regarding selected emergency events affecting county “C”. As the user travels into another county (i.e., county “A” having a FIPS code of 018097), received GPS signals will indicate this change and cause the stored FIPS code to change to 018097. As a result, the user will be informed regarding selected emergency events affecting county “A”, but will no longer be informed regarding emergency events affecting county “C”. Finally, as the user travels into yet another county (i.e., county “F” having a FIPS code of 018145), received GPS signals will indicate this change and cause the stored FIPS code to change to 018145. As a result, the user will be informed regarding selected emergency events affecting county “F”, but will no longer be informed regarding emergency events affecting county “A”.

As described herein, the present invention provides an apparatus and method for providing an emergency alert function for mobile units such as motor vehicles, airplanes, portable devices and/or any other type of mobile structures. While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An apparatus for providing an emergency alert function, comprising:
memory means for storing data including (i) location data that correlates first location information to second location information, and (ii) at least one user selected event type;
processing means for determining a current location using said location data and for processing a signal indicating an emergency event; and
wherein said processing means enables an alert output if said emergency event corresponds to said current location and said at least one user selected event type.

2. The apparatus of claim 1, wherein:
said first location information includes three-dimensional location coordinates; and
said second location information includes FIPS codes.

3. The apparatus of claim 1, wherein:
said processing means generates location coordinates responsive to a satellite signal and uses said location data to identify a location code that corresponds to said location coordinates; and
said location code represents said current location.

4. The apparatus of claim 3, wherein:
said location coordinates are represented in three-dimensions; and
said location code is a FIPS code.

5. The apparatus of claim 1, wherein said apparatus is included in a mobile unit.

6. A method for providing an emergency alert function for an apparatus, said method comprising steps of:
storing in a memory data including (i) location data that correlates first location information to second location information, and (ii) at least one user selected event type;
determining a current location using said location data
processing a signal indicating an emergency event; and
enabling an alert output if said emergency event corresponds to said current location and said at least one user selected event type.

7. The method of claim 6, wherein:
said first location information includes three-dimensional location coordinates; and
said second location information includes FIPS codes.

8. The method of claim 6, wherein said determining step comprises:
generating location coordinates responsive to a satellite signal;
using said location data to identify a location code that corresponds to said location coordinates; and
wherein said location code represents said current location.

9. The method of claim 8, wherein:
said location coordinates are represented in three-dimensions; and
said location code is a FIPS code.

10. The method of claim 6, wherein said apparatus is included in a mobile unit.

11. A television signal receiver having an emergency alert function, comprising:
a memory operative to store data including (i) location data that correlates first location information to second location information, and (ii) at least one user selected event type;
a processor coupled to said memory and being operative to determine a current location using said location data and to process a signal indicating an emergency event; and
wherein said processor enables an alert output if said emergency event corresponds to said current location and said at least one user selected event type.

12. The television signal receiver of claim 11, wherein:
said first location information includes three-dimensional location coordinates; and
said second location information includes FIPS codes.

13. The television signal receiver of claim 11, wherein:
said processor generates location coordinates responsive to a satellite signal and uses said location data to identify a location code that corresponds to said location coordinates; and
said location code represents said current location.

14. The television signal receiver of claim 13, wherein:
said location coordinates are represented in three-dimensions; and
said location code is a FIPS code.

15. The television signal receiver of claim 11, wherein said television signal receiver is included in a mobile unit.
